(19) United States
(12) Patent Application Publication
(10) Pub. No.: US 2019/0241440 A1
(43) Pub. Date: Aug. 8, 2019

(54) LOW-COST PROCESS OF MANUFACTURING TRANSPARENT SPINEL

(71) Applicant: RAFAEL ADVANCED DEFENSE SYSTEMS LTD., Haifa (IL)

(72) Inventors: Anat SHENHAR, Zichron Yaaqov (IL); Hila MELTZMAN, Misgav (IL); Dvir BLUMER, Haifa (IL); Tamar KADOSH, Kiryat Bialik (IL); Shimshon BAR-ZIV, Haifa (IL)

(73) Assignee: Rafael Advanced Defense Systems Ltd., Haifa (IL)

(21) Appl. No.: 16/317,602

(22) PCT Filed: Jun. 8, 2017
(86) PCT No.: PCT/IL2017/050642

§ 371 Date: Jan. 14, 2019

(30) Foreign Application Priority Data
Jul. 18, 2016 (IL) 246824

(51) Int. Cl. C01F 7/16; F41H 5/02

(52) U.S. Cl. CPC C01F 7/162; C01P 2006/60; C01P 2002/32; F41H 5/02

(57) ABSTRACT

The invention provides ballistic-resistant transparent objects of complex shapes consisting of magnesium aluminate spinel. The invention also provides a cost-effective industrial process for making the objects, including slip casting and sintering.

### FIELD OF THE INVENTION

The present invention relates to manufacturing ballistic-resistant transparent objects in a cost-effective industrial process. Particularly, the invention relates to spinel objects manufactured by slip casting and sintering.

### BACKGROUND OF THE INVENTION

Transparent ceramics are highly appreciated for the combination of excellent optical and mechanical properties, magnesium aluminate spinel (MgAl₂O₄) being one of the most promising materials. A high transmittance body can be obtained by a sintering process after reducing the amount of pores in the solid structure. This may be achieved by a pressing procedure selected from hot-press, isostatic-press, and uni-axial press, in which a pre-treated powder is mechanically pressed by direct mechanical pressure at the dry state. However, these processes are limited to relatively flat shapes and simple geometries. Furthermore, the equipment costs of such processes are very high, and often it is impossible to avoid material imperfections in the form of dots or stains which reduce the transparency of the product. An alternative process for manufacturing magnesium aluminate spinel is slurry casting, or slip casting, which obtains a green body before sintering by processing spinel powder suspensions. In order to achieve the required properties in the final sintered bodies, additives are admixed in the spinel powder, for example dopants or sintering additives. During the slip casting process, a part of the liquid is removed from the spinel slurry, which is achieved by absorbing the liquid in the porous mold walls, often made of gypsum, with or without the assistance of external pressure. Making a stable and homogeneous green body during slip casting requires adding auxiliary components to the suspension, which include dispersants. Frequent problems of slip casting processes include difficulties in obtaining a well-dispersed and reasonably viscous slurry, and in subsequent dewatering the dense suspension. A limited working life of the porous mold, which may even introduce impurities, further substantially increases the equipment costs. It is therefore an object of the invention to provide a method of preparing a transparent spinel object by slip casting without the known drawbacks, at a low scrap rate, and which can be implemented in industrial processes.

It is another object of this invention to provide a method of making ballistic stable, transparent spinel objects by slip casting without using gypsum molds.

It is still another object of this invention to provide a cost-effective process for manufacturing spinel transparent objects of variable shapes and various dimensions.

It is a still further object of this invention to provide ballistic-resistant and transparent spinel objects having a lateral dimension of up to 100 mm.

It is also another object of this invention to provide ballistic-resistant and transparent spinel objects having a lateral dimension of at least 100 mm.

It is a further object of this invention to provide a process for manufacturing spinel transparent flat objects having a width of up to 20 mm, and having lateral dimensions such as 200 mm or more.

This invention aims at providing spinel objects of various shapes for optical uses.

This invention also aims at providing highly transparent spinel objects of low haze and without visible inclusions, exhibiting hardness for ballistic-resistant use, of any desired shape and size, in a cost effective industrial process.

Other objects and advantages of present invention will appear as description proceeds.

### SUMMARY OF THE INVENTION

The present invention provides a high-yield and low-cost process of manufacturing a transparent object essentially consisting of magnesium aluminate spinel, comprising i) preparing an aqueous slurry comprising spinel powder, water, a dispersant, pH-adjusting agent, and an organic anti-thixotropic agent; ii) milling the slurry of step i) in a ball mill for at least 24 hours, whereby obtaining a suspension of fine spinel particles in aqueous solution, wherein the suspension contains at least 60 wt % non-aqueous components; iii) providing a mold having essentially the desired shape of said object, wherein the inner surface of the mold in contact with the slurry comprises a ceramic, polymeric or metallic filter with a pore size smaller than the particles in the slurry, such as a nano-pore polymeric filter, essentially impermeable to the particles of said spinel powder, the mold being hermetically sealed except for an inlet of said mold and for the pores of said polymeric filter; iv) pouring said suspension of fine spinel particles of step ii) into said mold of step iii) through said inlet; v) connecting said inlet with a pressure source and adjusting the pressure in said mold to a desired value, the pressure pushing the aqueous solution out of the mold; vi) keeping said pressure on until at least about 75% of the originally present liquid leaves the mold, whereby obtaining a green body; vii) extracting the green body from the mold and drying it by placing in a humidity-controlled environment, such as a chamber with humidity and temperature regulation; viii) heating the body at between 680 and 720° C. until the organic materials are removed; ix) sintering at about 1600° C. for between 1.5 and 2.5 hours; x) subjecting the body to hot isostatic pressing at 1650° C. and at a pressure of between 50 and 200 MPa in argon atmosphere; and xi) annealing the sintered and hot isostatically pressed body at about 1200° C. for 1 to 3 hours in air, and polishing the body to obtain said transparent object; wherein the process is a high-yield and low-cost process also due to the short-time production cycle, as well as due to the low scrap rate which enables a yield of at least 75% based on the used spinel powder. In a preferred embodiment, the process according to the invention comprises the steps of i) preparing an aqueous slurry wherein said slurry comprises at least 55 wt % pure spinel powder, between 0.5 and 3 wt % polyacrylate dispersant, ammonia to adjust the pH to at least 9, and between 0.5 and 4 wt %, such as between 1 and 4 wt % organic anti-thixotropic agent; ii) milling the slurry wherein said grinding is performed for at least 48 hours; iii) providing a mold wherein the inner surface of said mold is a polymeric filter to be in contact with said spinel particles; iv) pouring said suspension into said mold, optionally subjecting the mold to vibration; v) regulating the pressure in said mold to a pressure of up to 4 MPa; vi) obtaining a green body; vii) extracting the body from the mold and drying it in a humidity- and temperature-controlled environment; viii) burning out the organic materials at 700° C.; ix) sintering at about 1600° C. for about 2 hours; x) subjecting the body to hot isostatic pressing at 1650° C. and about 100 MPa for about 8 hours in argon atmosphere; and xi) annealing the sintered and hot-isostatically pressed body at 1200° C. for 2 hours in air, and polishing the body to obtain said transparent object.

In a preferred embodiment, the process according to the invention comprises the steps of i) preparing an aqueous slurry wherein said slurry comprises at least 55 wt % pure spinel powder, between 1 and 3 wt % polyacrylate dispersant, ammonia to adjust the pH to at least 10, and between 1 and 3 wt % organic anti-thixotropic agent; ii) milling the slurry wherein said grinding is performed for about 60 hours; iii) providing a mold wherein the inner surface of said mold is a polymeric nano-pore filter to be in contact with said spinel particles; iv) pouring said suspension into said mold, optionally subjecting the mold to vibration; v) regulating the pressure in said mold to a pressure of up to 4 MPa; vi) obtaining a green body; vii) extracting the body from the mold and drying it in a humidity- and temperature-controlled environment, providing humidity gradually from 95% to 35%; viii) burning out the organic materials at 700° C.; ix) sintering at about 1600° C. for about 2 hours; x) subjecting the body to hot isostatic pressing at 1650° C. and about 100 MPa for about 8 hours in argon atmosphere; and xi) annealing the sintered and annealed body at 1200° C. for 2 hours in air, and polishing the body to obtain said transparent object.

Said suspension in step ii) may contain up to about 70 wt % non-aqueous components. Said grinding mill may employ grinding balls of stable alumina, for example in an amount of between 3 and 9 times the weight of the spinel powder, for example 10 mm in diameter. The invention relates to a practical and up-scalable process of manufacturing transparent objects consisting of magnesium aluminate spinel and having complex shapes according to the above-described procedures, wherein the process i) comprises prolonged milling, and consequent casting of an aqueous slurry containing spinel powder and an organic anti-thixotropic agent into a mold comprising a nano-pore filter; and ii) enables a high-yield and low-cost production due to the short-time production cycle and due to the low scrap rate. Said mold can be reused for at least 5,000 production cycles, wherein the spinel yield is at least 75% due to said low scrap rate. The possibility to form near-net-shape articles may further contribute to the reduced costs, especially in the case of non-flat shapes.

The invention provides an aqueous slurry consisting of at least 60 wt % non-aqueous components, comprising at least 55 wt % pure spinel powder, between 0.5 and 3 wt %, such as between 1 and 2 wt % polyacrylate dispersant, pH-adjusting agent, such as ammonia to adjust the pH to at least 9, such as at least 10, and between 1 and 3 wt % organic anti-thixotropic agent. The aqueous slurry may consist of up to 75 wt %, for example up to 70 wt %, non-aqueous components. The slurry of the invention is advantageously employed in manufacturing superior transparent spinel objects by slip casting processes. The invention also provides transparent ballistic-resistant objects which essentially consist of magnesium aluminate spinel, prepared by slip casting the slurry of the invention as described, followed by sintering the body obtained by said slip casting. The transparent ballistic-resistant object of the invention may comprise a curved shape or any complex shape. In some embodiments, the object may have a thickness of at least 5 mm and/or a lateral dimension of at least 100 mm. The transparent ballistic-resistant object of the invention may have a width of up to 20 mm and/or a lateral dimension of 200 mm or more.

### BRIEF DESCRIPTION OF THE DRAWING

The above and other characteristics and advantages of the invention will be more readily apparent through the following examples, and with reference to the appended drawing, wherein:

FIG. 1 shows % transmission for two 6 mm-thick spinel specimens prepared by pressure-slip-casting according to one embodiment of the invention.

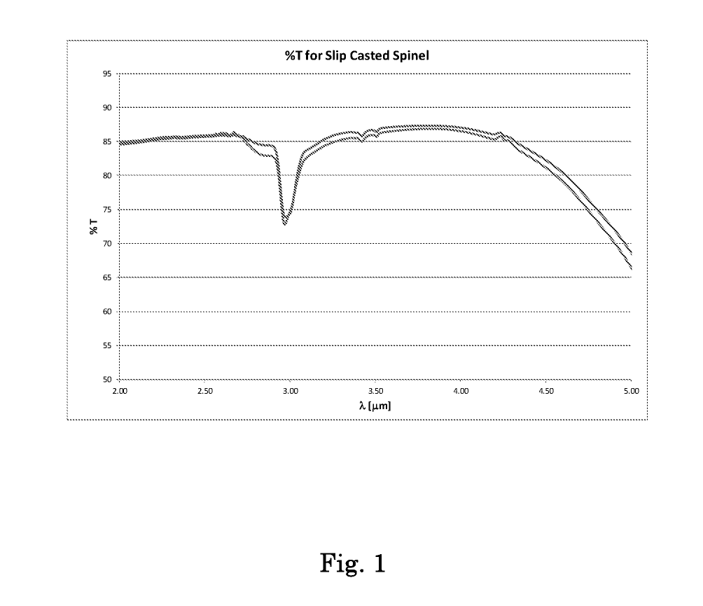

### DETAILED DESCRIPTION OF THE INVENTION

It has now been found that slip casting of spinel powder can provide highly transparent and ballistic resistant objects without defects by a scalable industrial process when i) including an organic anti-thixotropic agent in the spinel slurry, ii) placing the spinel slurry in a mold provided with a polymeric filter permeable to water, and iii) keeping the slurry in the mold under a pressure of at least 50 kPa. The anti-thixotropic agent may have a concentration of about 3 wt % relatively to the spinel powder. The slurry is preferably mixed for at least 48 hours, for example about 72 hours or about 96 hours with grinding balls.

A method according to the invention enables to obtain a slurry with very high solid loading of up to 75%, usually at least 60 wt %, such as at least 65 wt %, for example about 70 wt %. The quality of the final sintered product critically depends on the solid loading of the cast slurry, but it is usually difficult to increase the loading, particularly in case of fine powders used for transparent ceramics. The inventors believe that the use of a special anti-thixotropic additive enables to enhance the loading, and to maintain low viscosity over prolonged periods, such as several days. The term solid loading relates to the content of non-aqueous components in the mixture.

In a method according to the invention, the slurry is being dried in the mold to a sufficient degree for obtaining a stable green body. The spinel powder after grinding is sufficiently fine and results, after sintering and hot-isostatic pressing, in a transparent specimen that is completely free of any visible inclusions. In a preferred embodiment of the invention, the slurry is casted onto a mold containing a polymeric filter. Unlike pressing techniques, the slip casting process may provide flat, curved, and even lens-shaped and more complex forms in a near-final-shape manner. The lateral size of the articles can reach 100 mm or more, such as 200 mm or more, and the thickness can reach 20 mm or more. The method presented here, does not require the use of any sintering additives and results in a very fine microstructure (micron-sized grains). The fine grain size improves ballistic durability.

The invention enables to manufacture transparent objects consisting of magnesium aluminate spinel having complex shapes in practical up-scalable industrial process, in contrast to the previous techniques. The method of the invention results in a high-yield, production-scale, low-cost manufacturing process. This is possible due to the short-time production cycle, and due to the low scrap rate; the reproducible process according to the invention has, in some embodiments, a yield of at least 65%, such as at least 75% or at least 85%, for example at least 90%—a high yield for a complex technical ceramic production. In addition, the production doesn't require expensive molds and it can be easily up-scaled to hundreds or thousands of production units by minor additional costs. Each mold can be reused for at least 5,000 production cycles, The mold also enables a near-net-shape production that farther reduces polishing costs.

The method according to the invention enables to produce complex shapes, in a relatively simple and economic process which comprises steps of providing a raw material powder, de-agglomeration, forming a green body, burning, sintering, and hot isostatic pressing (HIP). The raw spinel powder is mixed in suspension with water and an organic anti-thixotropic agent, together with grinding balls, and with dispersants, for example ammonium polyacrylate, and additives, including ammonia and others according to the need, but without any metal or ceramic dopants or sintering additives. Special composition enables to reach a high solid content in the suspension of 40-75%; the solids are preferably between 60 and 75%—versus usually employed solid contents of 50-60%. The grinding balls, for example made of alumina, usually weigh 3-9 times the weight of the spinel powder, their diameter being for example 10 mm. The mixture may rotate in a drum for 3-4 days. A binder may be added. The suspension is cast to a mold under a pressure of up to 4 MPa, the body is extracted from the mold without damaging it and gradually dried by placing it in a humidity-controlled chamber and exposing to a controlled time, temperature, and relative humidity atmosphere (for example decreasing humidity from 95% to 35% during three days), and then the body is heated at about 700° C., and sintered in air at a temperature of about 1600° C., for example 1570° C., while reaching up to 99% theoretical density, such as between 94% and 98%, or between 96 and 98%, applying HIP at a pressure of up to 200 MPa, such as up to 100 MPa, in an argon atmosphere, possibly employing two different temperatures, for example comprising 1650° C., and annealing in air at a lower temperature, such as 1200° C., for example for two hours; the ceramic products finally undergo grinding and polishing. The width of a product is typically 5-8 mm and may reach 10 mm or more, such as 15 mm or more, for example 20 mm, compared to a typical width reached in known methods of up to between 4 and 5 mm. The product may be thinner when its application requires so, for example as thin as 1 mm.

In one embodiment of the invention, the cast slurry comprises a suspension of spinel powder in aqueous acrylate with, ammonia, and an organic anti-thixotropic agent in an amount of 1 to 6 wt % relatively to the spinel powder weight, for example between 2 and 5 wt %, such as between 3 and 4 wt %.

The invention preferably provides flat objects being 1-20 mm wide and having lateral dimensions hundreds mm times hundreds mm, for example 100 mm×100 mm or more, such as up to 200 mm×200 mm, such as up to 300 mm×300 mm, such as up to 400 mm×400 mm, such as up to 500 mm×500 mm. The objects can have any smaller size and any curved shape, and they can be utilized, for example, as shields, windows, domes, wherein the width of the ceramic layer may be uniform or varying along the object, such as in a lens-like structures.

Grain size in the spinel objects is usually in average about 3 micrometer. Mechanical strength, when measured by four point bending is usually greater than 270-350 MPa, according to the standard ASTM C1161-02C, on a specimen 4*3*45 mm. Knoop hardness at 0.2 kg typically reaches at least 1473 kg/mm², or 1243 kg/mm² at 1 kg. When replacing armored glass panes with the instant spinel product, total weight reduction of 50% or more may be attained. In a typical sample 4.5 mm wide, optical transparency is more than 71% for at the wavelength of 300 nm, more than 88% at 400 nm, and more than 85% at 600 nm, the luminous transmission being about 88% and the haze being less than 2%, according to the standard ASTM D1003. No inclusions greater than 0.1 mm are usually found, and the low cracking occurrence contributes to the high efficiency of the process (high material utilization, low scrap).

In a preferred embodiment of the slip casting process according to the invention, the slurry is pressed in the die by a pressure source providing a needed pressure, which may be up to 4 MPa, wherein a polymeric nano-pore filter is employed for removing liquid from the cast slurry. The slurry which is cast in the process according to the invention preferably comprises an organic anti-thixotropic agent, which enables to reach unusually high solid content in the slurry; the higher solid content results in better stability and homogeneity of the material during the whole casting and sintering process. The mentioned features also enable easier de-molding of the article. The slurry-casting process of the invention provides objects of very high ballistic efficiency at lower cost, when compared with known processes; moreover, the invention provides also improvements over known slip-casting process, including higher solid content of the slurry, facilitated extraction of the green object from the mold, more stable molds and cheaper mold production compared to producing usually employed gypsum molds, and less cracking problems in the objects. The special combination of the above technical features enables to increase the size of the objects, such as tiles, produced in the process, and ensures reliability and reproducibility of the process, which enables to employ the method in a cost-effective process of industrial scale.

The invention provides transparent spinel products without inclusions and a process of manufacturing spinel objects by slip casing, which products exhibit ballistic resistance, and which process enables to reproducibly create objects of variable shapes and various sizes.

The invention will be further described and illustrated in the following examples.

### Example

Spinel tiles having the dimensions of 7 mm×100 mm×100 mm were manufactured by a slip casting method according to one embodiment of the invention. A homogenous slurry was prepared, containing:

700 g high purity spinel powder (>99%),
350 g distilled water,
42.5 g polyacrylate dispersant (40%, darvan 821A, produced by Vanderbilt),
13 g ammonia (30%) to pH higher than 10,
20 g organic anti-thixotropic agent, and
2.5 kg alumina grinding balls.

The slurry contained 70 wt % solids and was mixed in a plastic container with milling balls for 96 hours. In some cases, 4 g binder, possibly Optapix AC170 from Zschimmer & Schwarz, was added.

A part of the slurry, 450 g, was cast into a porous mold comprising, on the inner surfaces a polymer filter. The lateral dimensions of the mold cavity were 130 mm×130 mm, and the slurry was poured into the mold, and the mold was sealed. Pressure source of 5 bar was applied for 8 hours. After de-molding, the casted specimen was dried by placing to a chamber with controlled humidity and temperature, the moisture gradually decreasing from 95% to 35% during three days, followed by burning stage 8 hours at 700° C., which removes the organics, and by sintering of 2 hours at 1600° C. in air. Final densification was achieved by a HIP (hot isostatic press) stage at 1650° C. and 1000 bar for 8 hours. After the densification step, an annealing step (re-oxidation) is performed at 1200° C. for 2 hours in air.

In-line transmission of a 4 mm layer was typically above 85% at a wavelength of between 0.4 and 4 μm, and haze less than 2%. Bending strength (4PB) was typically 275-330 MPa. Typical transmission of a cast-specimen contains a decrease in % transmission at about λ=2.96 μm, the decrease being typically from about 85% to 75% or less.

While this invention has been described in terms of some specific examples, many modifications and variations are possible. It is therefore understood that within the scope of the appended claims, the invention may be realized otherwise than as specifically described.

1. A high-yield and low-cost process of manufacturing a transparent object essentially consisting of magnesium aluminate spinel without metal dopants, comprising
i) preparing an aqueous slurry comprising at least 55 wt % pure spinel powder, water, a dispersant, a pH-adjusting agent, and an organic agent to maintain low viscosity, said slurry lacking metal dopants;
ii) milling the slurry of step i) in a ball mill for at least 24 hours, whereby obtaining a suspension of fine spinel particles in aqueous solution, wherein said organic agent enables to maintain low viscosity during said milling and over prolonged periods, and wherein the suspension contains at least 65 wt % non-aqueous components;
iii) providing a mold without employing gypsum, having essentially the desired shape of said object, wherein the inner surface of the mold in contact with the slurry is a nano-pore filter essentially impermeable to the particles of said spinel powder, the mold being hermetically sealed except for an inlet of said mold and for the pores of said filter;
iv) pouring said suspension of fine spinel particles of step ii) into said mold of step iii) through said inlet;
v) connecting said inlet with pressure source and adjusting the pressure in said mold to up to 4 MPa, the pressure pushing the aqueous solution through said filter out of the mold;
vi) keeping said pressure on until at least about 75% of the originally present liquid leaves the mold, whereby obtaining a green body;
vii) extracting the green body from the mold and drying it in a humidity-controlled environment;
viii) heating the body at between 680 and 720° C. until the organic materials are removed;
ix) sintering at about 1600° C. for between 1.5 and 2.5 hours;
x) subjecting the body to hot isostatic pressing at 1650° C. and at a pressure of between 50 and 200 MPa in argon atmosphere; and
xi) annealing the body at about 1200° C. for 1 to 3 hours in air, and polishing said body to obtain said transparent object;
thereby obtaining a transparent object without cracking problems essentially consisting of magnesium aluminate spinel in a high-yield and at a low-cost; and wherein the low scrap rate provides a yield of at least 75% based on the used spinel powder.

2. The process of claim 1, comprising
i) preparing said aqueous slurry wherein it comprises between 0.5 and 3 wt % acrylate-based dispersant, ammonia to adjust the pH to at least 9, and between 1 and 4 wt % of said organic agent;
ii) milling the slurry for at least 48 hours;
iii) providing said non-gypsum mold wherein said nano-pore filter is in contact with said spinel particles;
iv) pouring said suspension into said mold;
v) adjusting the pressure in said mold;
vi) obtaining said green body;
vii) extracting said body from the mold and drying it;
viii) burning the organic materials at 700° C.;
ix) sintering at about 1600° C. for about 2 hours;
x) subjecting the body to hot isostatic pressing at 1650° C. and at about 100 MPa for about 8 hours in argon atmosphere; and
xi) annealing the sintered body at 1200° C. for 2 hours in air, and polishing said body to obtain said transparent object.

3. The process of claim 1, comprising
i) preparing an aqueous slurry wherein said slurry comprises at least 60 wt % pure spinel powder, between 1 and 3 wt % polyacrylate dispersant, ammonia to adjust the pH to at least 10, and between 1 and 3 wt % of said organic agent;
ii) milling the slurry wherein said milling is performed for at least 60 hours;
iii) providing said mold;
iv) pouring said suspension into said mold;
v) adjusting the pressure source in said mold;
vi) obtaining a green body;
vii) extracting the body from the mold and drying it in a humidity- and temperature-controlled environment, providing humidity gradually from 95% to 35%;
viii) burning the organic materials at 700° C.;
ix) sintering at about 1600° C. for about 2 hours;
x) subjecting the body to hot isostatic pressing at 1650° C. and at about 100 MPa for about 8 hours in argon atmosphere; and
xi) annealing the sintered body at 1200° C. for 2 hours in air, and polishing said body to obtain said transparent object.

4. The process of claim 1, wherein said suspension in step ii) contains up to about 70 wt % non-aqueous components.

5. The process of claim 1, wherein said grinding mill employs grinding balls of alumina in an amount of between 3 and 9 times the weight of the spinel powder.

6. The practical and up-scalable process of manufacturing transparent objects consisting of magnesium aluminate spinel and having complex shapes according to claim 1, wherein the process
i) comprises prolonged milling and consequent casting of an aqueous slurry containing spinel powder, and an organic agent to maintain low viscosity over prolonged periods, into a mold comprising a nano-pore filter; and
ii) enables a high-yield and low-cost production due to the short-time production cycle and due to the low scrap rate.

7. The process of claim 6, wherein said mold can be reused for at least 5,000 production cycles, and wherein the spinel yield is at least 75% due to said low scrap rate.

8. An aqueous slurry consisting of at least 65 wt % non-aqueous components, comprising at least 55 wt % pure spinel powder without metal dopants, between 2 and 6 wt % polyacrylate dispersant, ammonia to adjust the pH to at least 10, and between 1 and 3 wt % organic agent to maintain low viscosity over prolonged periods.

9. The aqueous slurry of claim 8, consisting of up to 70 wt % non-aqueous components, for manufacturing transparent spinel objects by slip casting.

10. A transparent ballistic-resistant object, essentially consisting of magnesium aluminate spinel, prepared by slip casting the slurry of claim 8.

11. The transparent ballistic-resistant object of claim 10, comprising a curved shape.

12. The transparent ballistic-resistant object of claim 10, having a width of up to 5 mm and a lateral dimension of up to 100 mm.

13. The transparent ballistic-resistant object of claim 10, having a width of up to 20 mm a lateral dimension of 200 mm or more.
